(19) United States
(12) Patent Application Publication
(10) Pub. No.: US 2022/0206157 A1
(43) Pub. Date: Jun. 30, 2022

(54) PROTECTIVE HOUSING FOR A SENSING DEVICE

(71) Applicant: AGC GLASS EUROPE, Louvain-la-Neuve (BE)

(72) Inventors: Sébastien DELNEUFCOURT, Louvain-La-Neuve (BE); Jean MASSON, Gosselies (BE); Robert HICK, Chenee (BE); Frank BEKAERT, Ramillies (BE); Yannick SARTENAER, Vedrin (BE); Quentin FRASELLE, Mont Saint Guibert (BE)

(73) Assignee: AGC GLASS EUROPE, Louvain-la-Neuve (BE)

(21) Appl. No.: 17/605,428

(22) PCT Filed: Apr. 21, 2020
(86) PCT No.: PCT/EP2020/061058

§ 371 Date: Oct. 21, 2021

(30) Foreign Application Priority Data
Apr. 26, 2019 (EP) 19171313.0

(51) Int. Cl. G01S 17/894; G01S 7/481; G01S 17/931; G01S 7/4865

(52) U.S. Cl. CPC G01S 17/894; G01S 7/4813; G01S 7/4865; G01S 7/4817; G01S 7/4814; G01S 17/931

(57) ABSTRACT

A detection device which includes a LiDAR sensing device, a housing enclosing the LiDAR sensing device, and at least one cover lens. A portion of the cover lens is made of a glass sheet having an absorption coefficient lower than 5 m⁻¹ in the wavelength range from 750 to 1650 nm, preferably in the range of 750 to 1050 nm. The cover lens is fixed to the protective housing and is encapsulated.

### FIELD OF THE INVENTION

The invention relates to a detection device comprising a LiDAR sensing device and a protective housing enclosing said sensing device. Said protective housing comprises at least one cover lens. At least a portion of the cover lens is made of at least one glass sheet having an absorption coefficient lower than 5 m⁻¹ in the wavelength range from 750 to 1650 nm. Said cover lens is removable. Said protective housing provides improved protection against external degradation while maintaining excellent infrared transmission.

### PRIOR ART

Infrared-based remote sensing devices, such as LiDAR sensing devices, are technologies that measure distance to a target by illuminating that target with a pulsed laser light, and measuring the reflected pulses with a sensor. Differences in laser return times and wavelengths can then be used to make digital 3D-representations of the target. These instruments are commonly used in industrial, consumer and other applications for sensing movement, position, proximity, ambient light, speed, and direction. LiDAR sensing devices have a wide range of applications which can be of airborne and terrestrial type. Airborne LiDAR sensing devices are linked to a flying device such as plane, helicopter, drone, . . . Terrestrial applications can be both stationary or mobile. Stationary terrestrial scanning is indeed the most common survey method. Mobile scanning is used onto a moving vehicle to collect data along a path.

LiDAR sensing devices are popularly used to make high-resolution maps, with applications in amongst others agriculture for e.g. crop mapping or to apply appropriately costly fertilizer; archeology for e.g. providing an overview of broad, continuous features that may be indistinguishable on the ground; autonomous vehicles, for e.g. obstacle detection and avoidance to navigate safely through environments; atmospheric remote sensing and meteorology; military applications; physics and astronomy e.g. to measure the position of the moon, to produce precise global topographic surveys of planets; robotics for e.g. the perception of the environment as well as object classification to enable safe landing of robotic and manned vehicles with a high degree of precision; the combination of airborne and mobile terrestrial LiDAR sensing devices for surveying and mapping, wind farm optimization to e.g. to increase the energy output from wind farms by accurately measuring wind speeds and wind turbulence, solar photovoltaic deployment for e.g. optimizing solar photovoltaic systems at the city level by determining appropriate roof tops and for determining shading losses

In particular, in the field of autonomous vehicles, the current industry trend is to design truly autonomous cars. To approach such self-driving future, the number of sensors in vehicles will increase significantly. LiDAR sensing devices play a critical role in this development by providing the required sensory feedback from the vehicles' 360° environment.

Previous generations of LiDAR sensing devices were based on the emission of one to a few light pulses. In contrast, the new generation of LiDAR is of high resolution, based on the emission and reception of an array of light pulses. These LiDAR sensing devices require very high levels of infrared transmission to map physical features with very high resolution and produce extremely accurate results. Therefore, the new generation of LiDAR sensing devices is much more demanding in terms of optical properties and is therefore not fully compatible with conventional cover lenses of a protective housing. It is why the LiDAR sensing device according to the present invention has a cover lens wherein at least a portion of the cover lens is made of at least one glass sheet having an absorption coefficient lower than 5 m⁻¹ in the wavelength range from 750 to 1650 nm to provide the required high level of infrared transmission as well as the required mechanical resistance and chemical durability to a LiDAR sensing device. Thus, the glass cover has at least a portion made of infrared (IR) transparent glass to provide the required infrared transmission, especially for the novel generation of LiDARS sensing devices.

LiDAR sensing devices are indeed used in very different conditions and environment. The localization of the sensing devices is critical to operate at their best. They need to be located where that can have the largest and most effective overview of the target to be measured. For that reason, LiDAR sensing devices are generally very exposed to the external environment and could be damaged by the external conditions that can be very extreme and harsh.

Today, when the cover is damaged by for example by a stone impact, the LiDAR device is completely replaced first because the cover is permanently fixed to the protective housing and secondly because of potential risk of damage of damaging of the electronic and also because the suppliers of LiDAR do not wish to take the responsibility of use of damaged LiDAR.

Today, the cover lens is generally fixed to the protective housing by gluing. However, the gluing has several disadvantages.

First, the application process must be perfectly controlled to avoid a takeoff or leak during the serial life of the product. The temperature and humidity of the ambient air must be under control. It is also necessary to apply a primer of adhesion on the glass as well as on the plastic. The application of the glue must be carried out by an automated machine in order to ensure a constant volume of material. Too much glue will lead to an overflow of the glue when applying the glass, on the other hand, not enough glue will cause leaks in the case.

Then, there is a risk of pollution of the protective housing by the creation of glue filament between the machine nozzle and the plastic cover because of the viscosity. Once the glue is applied, there is an opening time for the glass to be positioned, otherwise the glue becomes too hard. This may also clog the machine's nozzle. It is therefore not recommended to use glue bead diameters that are too small.

Another problem with the use of glue, is tile consuming to complete the curing. Generally, it takes several hours to several days for the entire volume of the glue to polymerize. This therefore implies a buffer stock between the place of production and delivery.

The last problem of the aesthetic order is the presence of a gap between the glass and the plastic case. The dimensions of 2 elements can vary according to the cutting process for glass and injection for plastic, the 2 parts are dimensioned to be 100% sure that one fits into the other. The glass will therefore be cut smaller than the opening of the case.

Thus, there is a need a cover lens to protect LiDAR sensing devices from external degradation and removable in case of damage of the glass cover lens.

### SUMMARY OF THE INVENTION

The present invention concerns a detection device comprising:
(a) a LiDAR sensing device;
(b) a housing enclosing said LiDAR sensing device, and
(c) at least one cover lens; having at least a portion made of at least one glass sheet having an absorption coefficient lower than 5 m⁻¹ in the wavelength range from 750 to 1650 nm, preferably in the range of 750 to 1050 nm, more preferably in the range of 750 to 950 nm, the said cover lens being fixed to the protective housing.

According to the present invention, the at least one cover lens is encapsulated.

The present invention further concerns the use of a removable cover lens made of at least one glass sheet having an absorption coefficient lower than 5 m⁻¹ in the wavelength range comprised between 750 and 1650 nm, preferably in the range of 750 to 1050 nm, more preferably in the range of 750 to 950 nm, to protect a LiDAR sensing device from external degradation.

The present invention concerns also a process to manufacture a LiDAR device comprising an encapsulated glass cover fixed to the protective housing.

### BRIEF DESCRIPTION OF THE FIGURES

The accompanying Figures are included to provide a further understanding, and are incorporated in and constitute a part of this specification. The drawings of the Figures illustrate one or more embodiments, and together with the Detailed Description serve to explain principles and operations of the various embodiments. As such, the disclosure will become more fully understood from the following Detailed Description, taken in conjunction with the accompanying Figures, in which:

FIGS. 1(a) and 1(b) is a schematic LiDAR device according to prior art. according to an exemplary embodiment.

FIG. 2 is schematic LiDAR device according to an exemplary embodiment.

FIGS. 3(a) and 3(b) is schematic LiDAR device according to another exemplary embodiment.

### DETAILED DESCRIPTION

The detection device of the present invention comprises a LiDAR sensing device and a protective housing enclosing said LiDAR sensing device. The protective housing comprises at least a cover lens wherein at least a portion of the cover lens is made of at least one glass sheet having an absorption coefficient lower than 5 m⁻¹ in the wavelength range from 750 to 1650 nm, the said at least one cover lens is fixed to the protective housing.

According to the present invention, the at least one cover lens is encapsulated.

According to one embodiment, the cover lens fixed to the protective housing is a removable cover. The encapsulated cover lens may be fixed to the protective housing by reversible mechanical fastening means.

Mechanical fastening means may comprise fastening elements located at a peripheral region of the cover lens, outside of the field-of-view of the LiDAR device. The fastening elements may comprise first elements bonded to the inner surface of cover lens by for example complementary elements part of or fixed to the protective housing by encapsulation. The mechanical fastening and complementary elements preferably a reversible, may include a snap-fit assembly, a bayonet or threaded assembly, and the like. The advantage of reversible fastening means is that the cover lens can be removed and replaced or repaired in case of damage.

According to one embodiment of the present invention, the cover lens is encapsulated to a metallic or plastic frame to form an assembly. The assembly is then fixed to the protective housing by mechanical fastening means may comprise fastening elements located at a peripheral region of the cover lens, outside of the field-of-view of the LiDAR device. The fastening elements may comprise first elements bonded to the inner surface of cover lens by for example complementary elements part of or fixed to the protective housing by encapsulation. The mechanical fastening and complementary elements preferably a reversible, may include a snap-fit assembly, a bayonet or threaded assembly, and the like. The advantage of reversible fastening means is that the cover lens can be removed and replaced or repaired in case of damage.

Thus, with the proposed solution, if the cover lens is damaged, only the cover may be replaced because the cover lens is far from the LiDAR protecting efficiently the LiDAR itself ie its components like sensors, beams. Furthermore, is sufficiently resistant to not affect the LiDAR if cover lens is damaged.

According to one embodiment of the present invention, the at least one cover lens may comprise further a transparent wall. The second transparent wall may be optically coupled or not to the cover lens (e.g. with soft material matching the refractive index of the cover lens) and is expected to provide the same function. The transparent wall may be separated from the cover lens by space to improve the protection of the components of the LiDAR device (sensors, beams . . . ). The cover lens and the transparent wall sheet are then encapsulated for example in a frame made of metallic frame and a soft material. The frame comprising the two glass sheets are then fixed by reversible fastening means to the protective housing.

According to one embodiment of the present invention, the cover lens detection device is encapsulated in soft material, the soft material surrounding the periphery of the cover lens.

According to one embodiment of the present invention, the cover lens is encapsulated with the protective housing to form one piece.

Thanks to the present invention, the sealing (tightness) between the cover lens and the protective housing is ensured. Furthermore, the aesthetic of the LiDAR is improved since the cover lens may be flush with the edges of the protective housing.

According to one embodiment of the present invention, the material used to encapsulate the cover lens to the protective housing is chosen amongst PVC, TPE or PU. Thus, almost all bonding/gluing problems are eliminated or at least significantly decreased.

According to the present material, the soft material may be a thermoplastic polymer such as polypropylene, thermoplastic elastomers (TPE) such as olefinic thermoplastic elastomers (TPO), polyurethane, polyamide or soft polyvinyl chloride, Silicone or similar materials or any material suitable for reactive injection molding.

By using encapsulation process, the temperature of the injection mould and the material is more easily controlled because they are linked to press parameters. The volume of injected material may be also well managed and controlled to have a good encapsulation. As the injection is made into the tool cavity, there is no risk of material overflow or leakage. A primer may be used for the adhesion between the glass and the plastic but not between the 2 plastics.

Due to the plastic injection process itself, there is no need to observe a waiting time for gluing.

Apart from the cooling time of the material, which is a few minutes in the open air, the part can be sent directly to the customer.

Regarding aesthetics, encapsulation compensates for glass cutting and shape tolerances of the plastic case. Furthermore, the cover lens may be flush with the protective housing.

In the case of an encapsulation of the at least one cover lens directly to the protective housing forming then one piece, the limp is first injected. Then, arriving at the position of the glass, the injection material is injected into the cavity created between the 2 parts. Since this process is carried out under high pressure. The process is safe to fill this area perfectly and therefore significantly improves the tightness and adhesion between the glass and the housing. From the outside, a perfectly flush appearance may be obtained between the different elements ie the cover lens and the protective housing.

According to one embodiment of the present invention, the cover lens may be provided with a primer for the adhesion between the hard material and the encapsulating material.

The LiDAR sensing device of the present invention (also written Lidar, LIDAR or LADAR—being the acronym of Light Detection And Ranging) is a technology that measures distance by illuminating a target with an infrared (IR) laser light, and measuring the reflected pulses with a sensor. Distance to the target is determined by recording the time between transmitted and backscattered pulses and by using the speed of light to calculate the distance traveled. It can then be used to make digital 3D-representations of the target.

LiDARs have a wide range of applications which can be of airborne or terrestrial types. These different types of applications require scanners with varying specifications based on the data's purpose, the size of the area to be captured, the range of measurement desired, the cost of equipment, and more.

In general, a LiDAR sensing device is an optoelectronic system which is composed of several major components: (1) at least a laser transmitter. It is preferred that the laser transmitter of the LiDAR sensing device of the present invention transmits principally in infrared wavelength from 700 nm to 1 mm, preferably in the near infrared wavelength 780 nm to 3 μm, more preferably in the wavelength range from 750 to 1650 nm; (2) at least a receiver comprising a light collector (telescope or other optics). Several scanning technologies are available such dual oscillating plane mirrors, combination with polygon mirrors and dual axis scanners. Optic choices affect the angular resolution and range that can be detected. A hole mirror or a beam splitter can be used as light collectors. (3) at least a photodetector which converts the light into an electrical signal; and an electronic processing chain signal that extracts the information sought. Preferably, the LiDAR sensing device to be used in the present invention, is a new generation LiDAR sensing device based on scanning, rotating, flashing or solid state LiDAR. The scanning or rotating LiDARs are using moving lasers beams while flashing and solid state LiDAR emits light pulses which reflect off objects.

The protective housing can be made from any regular material known to make protective housing, such as any suitable metal material (aluminum, . . . ), plastic material (PVC, PVC coated with polyester, polypropylene HD, polyethylene . . .) opaque and/or transparent, and combinations thereof. The housing shape will generally be linked to the shape of the LiDAR sensing device for better protection. LiDAR sensing devices can comprise several different parts that can be fixed or rotating. Common LiDARs' shape refers to “mushrooms-like” devices popping up the platform where they are located.

The protective housing will comprise at least one cover lens. The housing may comprise two cover lenses, one dedicated to the emission and the other dedicated to the reflection, or more.

For avoidance of doubt, visible light is defined as having wavelengths in the range of 400 to 700 nm.

According to the invention, the glass sheet has an absorption coefficient lower than 5 m⁻¹ in the wavelength range from 750 to 1650 nm. To quantify the low absorption of the glass sheet in the infrared range, in the present description, the absorption coefficient is used in the wavelength range from 750 to 1650 nm. The absorption coefficient is defined by the ratio between the absorbance and the optical path length traversed by electromagnetic radiation in a given environment. It is expressed in m⁻¹. It is therefore independent of the thickness of the material but it is function of the wavelength of the absorbed radiation and the chemical nature of the material.

In the case of glass, the absorption coefficient (μ) at a chosen wavelength λ can be calculated from a measurement in transmission (T) as well as the refractive index n of the material (thick=thickness), the values of n, ρ and T being a function of the chosen wavelength λ:

$$μ = - \frac{1}{thick} \cdot ln [ \frac{- {( 1 - ρ )}^{2} + \sqrt{{( 1 - ρ )}^{4} + 4 \cdot {T}^{2} \cdot {ρ}^{2}}}{2 \cdot T \cdot {ρ}^{2}} ]$$

$$with ρ = {( n - 1 )}^{2} / {( n + 1 )}^{2} .$$

The glass sheet according to the invention preferably has an absorption coefficient in the wavelength range of 750 to 1650 nm, generally used in optical technologies relating to the invention, very low compared to conventional glasses (as the said “clear glass” to which such a coefficient is about 30 m⁻¹ order). In particular, the glass sheet according to the invention has an absorption coefficient in the wavelength range from 750 to 1650 nm lower than 5 m⁻¹.

Glass sheet are those for example well described in the patent application WO2019030106. The glass compositions described in WO2019030106 are incorporated here by reference.

In addition to its basic composition, the glass may include other components, nature and adapted according to quantity of the desired effect.

A solution proposed in the invention to obtain a very transparent glass in the near infrared (IR), with weak or no impact on its aesthetic or its color, is to combine in the glass composition a low iron quantity and chromium in a range of specific contents.

Such glass compositions combining low levels of iron and chromium showed particularly good performance in terms of infrared transmission and show a high transparency in the visible and a little marked tint, near a glass called “extra-clear ”.

According to the present invention, the glass sheet of the cover lens within the protective housing, may be in the form of planar sheets or may be curved.

It can be advantageous to add one or more of the useful functionalities to the glass sheet of the cover lens of the present invention as described in patent application WO2019030106.

Before turning to Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

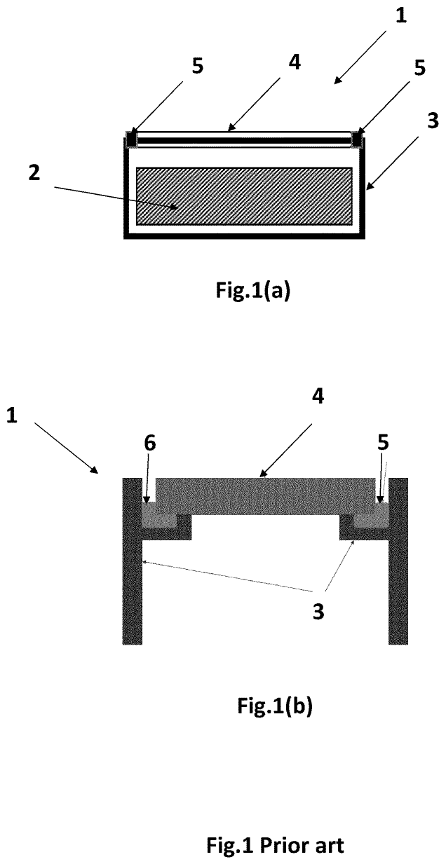

Referring to FIG. 1(a) which represents schematically a LiDAR device according the prior art, the detection devive 1 is composed by a LiDAR sensing device 2 including optical componentry, such as reflectors, a beam splitter, and optical sensors, for example (not shown). According to an exemplary embodiment, the LiDAR sensing device 2 is protected by a protective housing 3. A glass cover lens 4 (or a plastic cover) forming a wall or a window surrounding or adjoining the optical componentry is provided. In operation, light may pass through the glass cover lens 4 to and/or from the optical componentry of the LiDAR sensing device 2. In prior art, the glass cover lens (or plastic cover) is permanently fixed to the protective housing of the LiDAR sensing device 2. Generally, the cover lens is fixed by gluing 5 the cover lens to the protective housing. Thus, when the cover lens is damaged, the LiDAR has to be replaced totally leading to an over cost.

In FIG. 1(b), representing also prior art in a standard section of a glued cover lens 4 on the protective housing 3. As shown in FIG. 1(b), a gap 6 is present between the glass cover lens 4 and the plastic protective housing 3, which is essential to compensate the tolerances of the different manufacturing processes. It can therefore be seen that from outside the protective housing 3, this gap is perfectly visible. In addition, when positioning the glass cover lens 4, there is a risk that the glue 5 will overflow either towards the outside of the housing 3 but also towards the inside which would also imply that the glass 4 does not touch the stop and that it is therefore incorrectly positioned.

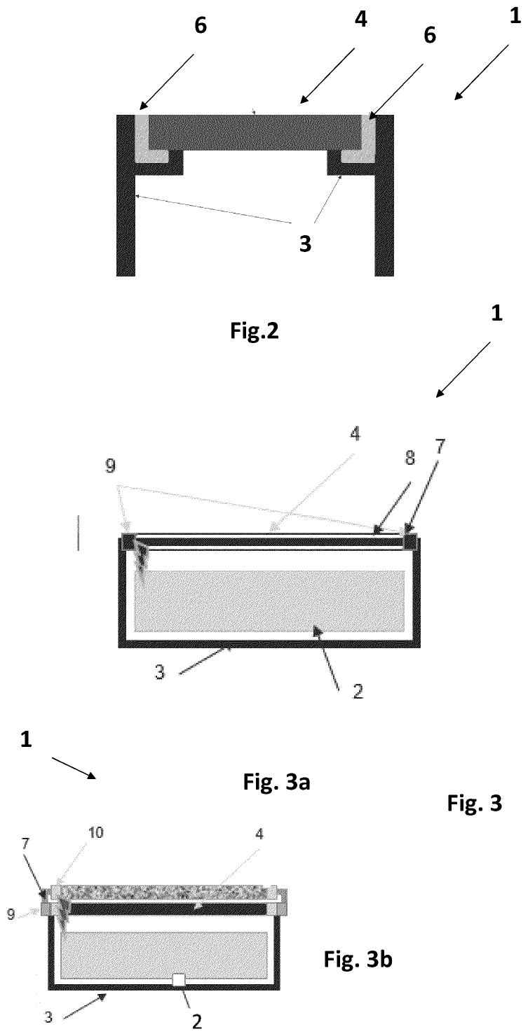

FIG. 2 represents one embodiment of the present invention. FIG. 2 represent a schematic representation of the encapsulation of the cover glass 4 directly to the protective housing 3. The cover lens 4 and the protective housing forms thus one piece. The manufacturing of the protective housing 3 comprising the sensing system (not shown) may be formed in the same process than the encapsulation of the glass cover lens 4 to the protective housing 3. In the case of an encapsulation, the plastic protective housing 3 is first injected in an appropriate material. Then, at the position level of the glass cover 4, an encapsulation material as a soft material for example is injected into the cavity created between the glass cover lens 4 and the protective housing 3. Since this process is carried out under high pressure, it is safe to fill this area perfectly and therefore significantly improves the tightness and adhesion between the glass and the housing. From the outside, a perfectly flush appearance is obtained between the different elements.

FIGS. 3(a) and (b) represents one embodiment of the present invention wherein the cover lens 4 is first encapsulated into a frame 7 made of metal and soft material or encapsulated in a soft material to form an assembly 8. The assembly 8 is then fixed to the protective housing 3 by reversible fastening means 9 such as screws, glue beads or any suitable material. Thus, if the cover lens 4 is damaged for example by a stone impact, only the glass cover lens 4 should be replaced and not the entire detection device 1 leading to a reduction cost in case of LiDAR damage. The cover lens is then a removable and replaceable cover lens 4.

In FIG. 3 (b), the cover lens 4 is further protected by a transparent wall 10 having properties to be coupled to cover lens 4 and to work with the sensing system 2 ie the component of the detection device 1. The transparent wall 10 is fixed to the cover lens by encapsulation in a frame 7 made of metal or made of metal or plastic. The transparent wall 10 is positioned toward the external environment to better protect the cover lens 4 and consequently the detection device form external aggression like stone impact. The assembly 8 formed by the transparent wall 10, the glass cover 4 and the frame 7 is then fixed to the protective housing by reversible fastening mean leading to an easy replacement of the transparent wall 10 and/or the cover lens 4. As for the embodiment described in FIG. 3 (a), the reversible fastening means may be screws, glue beads or any suitable material well know from the skilled person.

According to the present invention, the LiDAR device may be placed in any vehicle like car, van, truck, plane, train, helicopter . . . the Lidar device may positioned on bumper, appliques, roof.

1. A detection device comprising:
a. a LiDAR sensing device;
b. a protective housing enclosing said the LiDAR sensing device;
c. at least one cover lens; made of at least one glass sheet having an absorption coefficient lower than 5 m⁻¹ in the a wavelength range from 750 to 1650 nm, the cover lens being fixed to the protective housing,
wherein, the cover lens is encapsulated.

2. The detection device according to claim 1, wherein the cover lens is a removable cover.

3. The detection device according to claim 1, wherein the cover lens is encapsulated to a metallic or plastic frame to form an assembly.

4. The detection device according to claim 3, wherein the assembly is fixed to the protective housing by a reversible fastening means.

5. The detection device according to claim 1, wherein the cover lens is encapsulated in soft material, wherein the soft material surrounds a periphery of the cover lens.

6. The detection device according to claim 5, wherein the cover lens is fixed to the protective housing by encapsulation forming one piece.

7. The detection device according to claim 1, wherein the detection device is positioned on a vehicle.

8. The detection device according to claim 1, wherein the LIDAR sensing device is a scanning, rotating, flashing or solid state LiDAR device enabling 3D mapping, and emitting a laser beam of wavelength ranging between 750 and 1650 nm.

9. A process to manufacture a LiDAR device according to claim 1, comprising:
a. Providing the protective housing,
b. Encapsulating at least one part of the cover lens, and
c. Fixing the encapsulated cover lens to the protective housing.

10. The process according to claim 9, wherein the protective housing and the cover lens are encapsulated together in an encapsulation mould to form one piece.

11. The process according to claim 9, wherein the cover lens is flush with peripheral edges of the protective housing.

12. The process according to claim 9, wherein the cover lens is encapsulated into a frame made of metal and/or soft material to form an assembly, wherein the assembly is fixed to the protective housing by a reversible fastening means.

13. The process according to claim 12, wherein the assembly comprises a transparent wall facing an external environment to protect the cover lens.

14. The detection device according to claim 1, wherein the LIDAR sensing device is a scanning, rotating, flashing or solid state LiDAR device enabling 3D mapping, and emitting a laser beam of wavelength ranging between 750 and 1050 nm.

15. The detection device according to claim 1, wherein the detection device comprises at least one cover lens made of at least one glass sheet having an absorption coefficient lower than 5 m⁻¹ in a wavelength range of 750 to 1050 nm.

16. The detection device according to claim 1, wherein the detection device comprises at least one cover lens made of at least one glass sheet having an absorption coefficient lower than 5 m⁻¹ in a wavelength range of 750 to 950 nm.

17. The detection device according to claim 7, wherein the detection device is positioned on the vehicle's bumpers, applique, or roof.
